(19) United States
(12) Patent Application Publication
(10) Pub. No.: US 2026/0085594 A1
(43) Pub. Date: Mar. 26, 2026

(54) RETRIEVING HAZARDOUS WASTE STORED IN A DRILLHOLE

(71) Applicant: Deep Isolation, Inc., Berkeley, CA (US)

(72) Inventors: Richard A. Muller, Berkeley, CA (US); Elizabeth Muller, Berkeley, CA (US)

(21) Appl. No.: 19/112,834

(22) PCT Filed: Sep. 29, 2023
(86) PCT No.: PCT/US2023/034081

§ 371 Date: Mar. 18, 2025

Related U.S. Application Data
(60) Provisional application No. 63/411,691, filed on Sep. 30, 2022.

(51) Int. Cl. E21B 41/00; G21F 9/36

(52) U.S. Cl. CPC E21B 41/005; G21F 9/36

(57) ABSTRACT

A hazardous waste canister includes a housing that defines an interior volume configured to store nuclear waste, the housing configured to enclose the nuclear waste in a human-unoccupiable drillhole formed from a terranean surface into a subterranean formation; and a knob coupled to the housing at an end of the canister, the knob configured to attach to a set of latching calipers of a latching assembly coupled to a downhole conveyance for moving the canister from the human-unoccupiable drillhole to the terranean surface.

### TECHNICAL FIELD

This disclosure relates to the retrieval of hazardous waste, such as radioactive waste, that is at least temporarily stored in a drillhole.

### BACKGROUND

Hazardous waste is often placed in long-term, permanent, or semi-permanent storage so as to prevent health issues among a population living near the stored waste. Such hazardous waste storage is often challenging, for example, in terms of storage location identification and surety of containment. For instance, the safe storage of nuclear waste (e.g., spent nuclear fuel, whether from commercial power reactors, test reactors, or even military waste) is considered to be one of the outstanding challenges of energy technology. Safe storage of the long-lived radioactive waste is a major impediment to the adoption of nuclear power in the United States and around the world. Conventional waste storage methods have emphasized the use of tunnels and is exemplified by the design of the Yucca Mountain storage facility. Other techniques include boreholes, including vertical boreholes, drilled into crystalline basement rock. Other conventional techniques include forming a tunnel with boreholes emanating from the walls of the tunnel in shallow formations to allow human access.

### SUMMARY

In a first example implementation, a hazardous waste canister includes a housing that defines an interior volume configured to store nuclear waste, the housing configured to enclose the nuclear waste in a human-unoccupiable drillhole formed from a terranean surface into a subterranean formation; and a knob coupled to the housing at an end of the canister, the knob configured to attach to a set of latching calipers of a latching assembly coupled to a downhole conveyance for moving the canister from the human-unoccupiable drillhole to the terranean surface.

In an aspect combinable with the first example implementation, the knob is coupled or attached to an end of the housing.

In another aspect combinable with any of the previous aspects of the first example implementation, the set of latching calipers comprises a first set of latching calipers, and the canister comprises a lip configured to couple to a second set of latching calipers of the latching assembly.

In another aspect combinable with any of the previous aspects of the first example implementation, the lip is at the end of the canister.

In another aspect combinable with any of the previous aspects of the first example implementation, the housing comprises a corrosion resistant material.

In another aspect combinable with any of the previous aspects of the first example implementation, the corrosion resistant material is identical to a material of a casing installed in the drillhole.

In another aspect combinable with any of the previous aspects of the first example implementation, the downhole conveyance comprises a wireline.

In another aspect combinable with any of the previous aspects of the first example implementation, the nuclear waste comprises spent nuclear fuel.

Another aspect combinable with any of the previous aspects of the first example implementation further includes a plurality of runners installed on the housing.

In another aspect combinable with any of the previous aspects of the first example implementation, the plurality of runners comprises an electrically insulating material.

In a second example implementation, a downhole tool includes a top sub-assembly configured to couple to a downhole conveyance; and a latching assembly. The latching assembly includes at least one set of latching calipers configured to couple to a knob attached to a housing at an end of a hazardous waste canister, the housing defining an interior volume configured to store nuclear waste in a human-unoccupiable drillhole formed from a terranean surface into a subterranean formation; and a locking ring configured to secure the at least one set of latching calipers coupled to the knob.

In an aspect combinable with the second example implementation, the downhole conveyance comprises a wireline.

In another aspect combinable with any of the previous aspects of the second example implementation, the at least one set of latching calipers comprises a first set of latching calipers and a second set of latching calipers.

In another aspect combinable with any of the previous aspects of the second example implementation, the first set of latching calipers is configured to couple to the knob attached to the housing at an end of the hazardous waste canister.

In another aspect combinable with any of the previous aspects of the second example implementation, the second set of latching calipers is configured to couple to an outer lip of the housing.

In a third example implementation, a hazardous waste repository includes a human-unoccupiable drillhole formed from a terranean surface into a subterranean formation, the drillhole comprising a disposal region configured to emplace at least one hazardous waste canister that enclose hazardous waste; and a casing installed in at least a portion of the drillhole, the casing comprising stainless steel, Teflon, or plastic.

In an aspect combinable with the third example implementation, the casing and the canister are made from the same material.

Another aspect combinable with any of the previous aspects of the third example implementation further includes electrical insulation positioned between a portion of the casing and the canister.

Another aspect combinable with any of the previous aspects of the third example implementation further includes a sacrificial anode positioned in the drillhole adjacent the canister.

In another aspect combinable with any of the previous aspects of the third example implementation, the casing comprises a plurality of casing joints welded together.

Another aspect combinable with any of the previous aspects of the third example implementation further includes cement installed between the casing and the subterranean formation.

In another aspect combinable with any of the previous aspects of the third example implementation, the cement is formed with a corrosion-inhibiting fluid.

Another aspect combinable with any of the previous aspects of the third example implementation further includes a corrosion-inhibiting fluid circulated into the drillhole between the casing and the canister.

Another aspect combinable with any of the previous aspects of the third example implementation further includes one or more tracks installed on an inner surface of the casing to facilitate movement of the canister in the drillhole.

In another aspect combinable with any of the previous aspects of the third example implementation, the one or more tracks are made of a corrosion-resistant material.

In a fourth example implementation, a hazardous waste repository includes a human-unoccupiable drillhole formed from a terranean surface into a subterranean formation. The drillhole includes a first access drillhole portion formed from the terranean surface toward or into the subterranean formation; a second access drillhole portion formed from the terranean surface toward or into the subterranean formation; and a disposal drillhole region formed in the subterranean formation and configured to emplace one or more hazardous waste canisters that enclose hazardous waste, wherein the disposal drillhole region is coupled within the subterranean formation to the first and second access drillhole portions.

In an aspect combinable with the fourth example implementation, the first and second access drillhole portion displace vertically and laterally from respective first and second entry drillhole portions.

In another aspect combinable with any of the previous aspects of the fourth example implementation, the disposal drillhole region is circular in shape.

In another aspect combinable with any of the previous aspects of the fourth example implementation, the human-occupiable drillhole comprises a flow path for a fluid to be circulated therethrough.

In another aspect combinable with any of the previous aspects of the fourth example implementation, the flow path comprises an inlet at the first access drillhole portion and an outlet at the second drillhole portion.

In another aspect combinable with any of the previous aspects of the fourth example implementation, the one or more hazardous waste canisters comprises a plurality of hazardous waste canisters emplaced in the disposal drillhole region, each of the plurality of hazardous waste canisters enclosing hazardous waste.

Another aspect combinable with any of the previous aspects of the fourth example implementation further includes at least one dummy canister that does not include hazardous waste.

In another aspect combinable with any of the previous aspects of the fourth example implementation, the at least one dummy canister comprises a first dummy canister positioned at a first end of the plurality of hazardous waste canisters and a second dummy canister positioned at a second end of the plurality of hazardous waste canisters opposite the first end.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic illustration of an example implementation of a hazardous waste repository formed in a drillhole to store hazardous waste in one or more hazardous waste canisters according to the present disclosure.

FIGS. 2A-2D are schematic illustrations of an example implementation of a latching mechanism that can be used with a downhole conveyance to retrieve a hazardous waste canister from emplacement within a hazardous waste repository formed in a drillhole according to the present disclosure.

FIGS. 3A-3D are isometric schematic illustrations of the example implementation of the latching mechanism of FIGS. 2A-2D according to the present disclosure.

FIG. 4 is a schematic illustration of an example implementation of a hazardous waste canister according to the present disclosure.

FIGS. 5A and 5B are schematic illustrations that show side and plan views, respectively, of an example implementation of a hazardous waste repository formed in a drillhole to store hazardous waste in one or more hazardous waste canisters according to the present disclosure.

### DETAILED DESCRIPTION

The present disclosure describes example implementations of apparatus, systems, and methods for the retrieval of hazardous waste (such as nuclear waste) that is emplaced in a hazardous waste repository formed in a deep, directional (or vertical or slanted) drillhole within a subterranean formation. Such example implementations of apparatus, systems, and methods for the retrieval of hazardous waste can be used to retrieve the stored waste for a period of time, such as 100 years, after emplacement. In example implementations, the hazardous waste repository comprises an access drillhole portion (e.g., vertical and then curved toward a horizontal portion) that is about 1-2 km in length (e.g., drilled distance). Coupled to the access drillhole portion is a disposal drillhole portion that can be another 1 to 2 km in length. In some aspects, the access drillhole portion is kept free of hazardous waste, but can be sealed (such as by a retrievable packer or plug) and then reopened for waste retrieval.

In the example implementation, 100-year retrievability can be achieved with minimal or no modification of a hazardous waste repository that is designed, for instance, for no retrieval or earlier retrieval than 100 years. Such design can include, for example, a carbon-steel casing cemented or otherwise installed in the drillhole, carbon-steel or corrosion-resistant metal canisters that enclose the nuclear waste, subterranean brine that can fill the drillhole around the canisters, and a connector installed on the canisters for retrieval by a downhole conveyance (such as in a fishing operation). However, implementations according to the present disclosure can increase the confidence that retrieval can be achieved if desired after 100 years of emplacement.

In some aspects, there can be several criteria that must be met for retrieval. For example, one criteria can be that the canister must remain intact and sealed and capable of safely enduring a sufficient pulling force (e.g., by the conveyance) to the terranean surface. As another example, another criteria can be that there must be a robust latching mechanism on the canister that assures that even if some corrosion occurs in the canister (e.g., a few millimeters of rust in the threads of the latching device, or other clogging from well debris), that even after 100 years, a secure attachment between a retrieval conveyance and the canister can be made. As another example, another criteria can be that the casing must be sufficiently mechanically robust that after 100 years it will not collapse or otherwise constrict in such a way that the canister cannot be moved there through. As another example, another criteria can be that corrosion of an inner surface (e.g., opposite the subterranean formation) of the casing (or liner, if one is used) can be kept to a sufficiently low level that it does not impede the retrieval of the canister, cause excess friction, or change the shape of the casing/liner surface so much that there are points or regions within the drillhole in which a moving canister can get stuck.

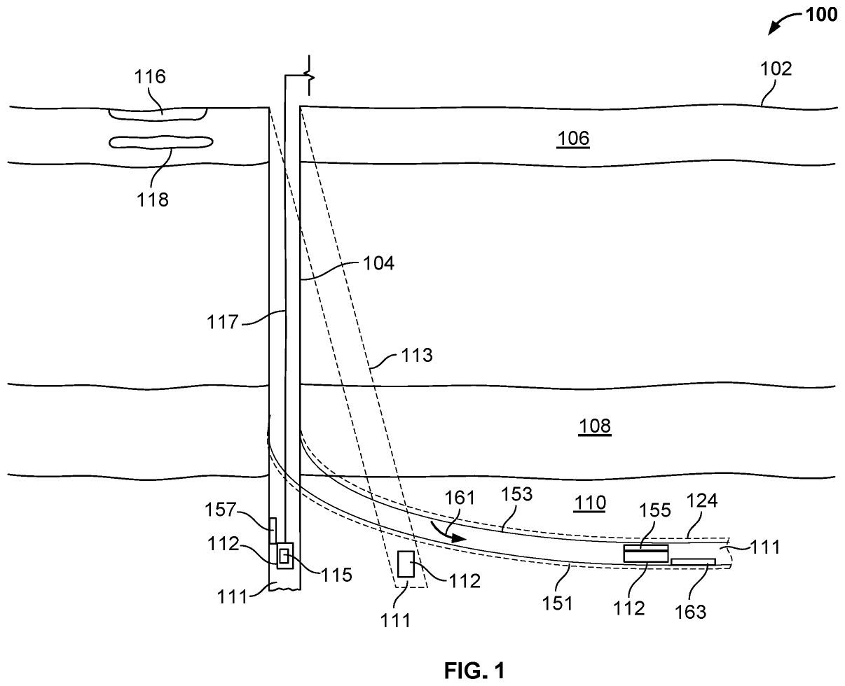

FIG. 1 is a schematic illustration of an example implementation of a hazardous waste repository 100 formed in a drillhole to store hazardous waste in one or more hazardous waste canisters according to the present disclosure. As shown in this example, one or more human-unoccupiable wellbores 104 (e.g., drillholes or boreholes) can be formed (e.g., drilled) from the Earth's surface 102 into a subterranean formation 110 that is suitable for the storage (temporary or permanent) of hazardous waste (e.g., chemical waste, biological waste, radioactive waste, etc.) in one or more hazardous waste canisters 112. In some aspects, the wellbores 104 are only vertical (or substantially vertical taking into account slight offsets due to the drilling process). As shown in FIG. 1, the wellbore 104 can be vertical, tilted (such as slant wellbore 113), or have a gradually changing direction (such as horizontal portion 124 coupled to wellbore 104 through a curved portion).

In some aspects, the wellbores 104 include non-vertical portions 124, such as curved or horizontal (or substantially horizontal) portions that are coupled to vertical portions that extend into the Earth, through subterranean formations 106 and 108, from the surface 102, and into the salt formation 110. In some aspects, one or more formations, such as a surface formation 106, may include surface water 116 or sub-surface, mobile water 118. One or more canisters 112 containing hazardous waste 115 is positioned (e.g., on a downhole conveyance 117 such as a wireline or other form of conveyance) in a storage portion 111 of the wellbores 104 that is located in the subterranean formation 110. In some aspects, all or a part of the wellbore 104 (such as a portion close to the surface 102) may be cased with a casing 153 that is secured with cement 151 (or other hardenable material).

Hazardous waste can include radioactive waste, such as spent nuclear fuel, high level waste, TRansUranic (TRU) waste, or other forms of nuclear or radioactive waste. Retrievability of such waste (and other forms of non-radioactive waste) can be desirable. For example, a state of decay or decomposition of the waste may need to be checked after certain periods of time. In some aspects, it may be desirable to check on a state of the hazardous waste canister 112 that stores the waste. In some aspects, an event, such as a seismic event, may trigger an action to retrieve the hazardous waste canister 112 and waste 115 for inspection of one or both. There can be several example implementations of apparatus, systems, and methods disclosed herein that provide for the desired retrievability, such as retrievability up to 100 years from emplacement of the hazardous waste canisters 112 in the storage portion 111 of the example wellbores 104 (and 113 and 124).

For example, 100-year retrievability can also include systems and methods for casing corrosion reduction. In oil and gas drilling, as well as in carbon storage and sequestration, much if not most of the corrosion of a wellbore casing occurs by chemical interaction of iron in the casing with hydrogen sulfide (H₂S) and CO₂ in the interior of the casing. These gases are often present in the oil and gas being extracted, and they would be present only at very low levels in a deep, directional drillhole that includes a hazardous waste repository. However, additional confirmation of a 100-year retrievability can be gained by making the casing 153 corrosion resistant. For example, in some aspects, the casing 153 (or more specifically, tubular casing joints that are connected to form the casing) can be constructed of a corrosion-resistant material, such as stainless steel, Teflon, or plastic.

As another example, the casing 153 can be coated with corrosion-resistant materials. In some aspects, the coating (such as paint, epoxy, chrome, quartz, or diamond) can be applied to an inner surface of the casing 153, an outer surface of the casing 153, or both. These coatings can also protect the surface(s) of the casing 153 from scratches when the canister is installed in the drillhole 104, and absence of scratches can also provide for increased corrosion resistance. In some aspects, soft coatings (e.g., paint or epoxy) may not provide millennium-length corrosion resistance. However, when concerning with century-length corrosion resistance, they can be adequate for 100-year retrievability. Should the drillhole 104 for the hazardous waste repository include a wellbore liner (which can also be represented as 153 and be in place of or in addition to a casing), a coating can be applied to the liner as well as to the casing 153, or only to the liner.

As another example, corrosion resistance can be increased by a corrosion current reduction. When two different metals with different electrochemical potentials are in electric contact, the movement of electrons from one to the other creates a voltage difference between the two. If both are in contact with an electrolyte, then ions can move into that electrolyte and result in corrosion, that is, chemical reactions on the surface. The corrosion takes place in the metal that has the weaker electrochemical potential.

There are several ways to reduce or eliminate such corrosion currents. For example, matching metals can be used for the canister 112 and the casing 153. For instance, the canister 112 can be made of the same metal or alloy that is used for the casing 153. Doing so can avoid corrosion currents between the canister 112 and the casing 153. In some aspects, the corrosion in the canister 112 may be considered to be more detrimental than corrosion of the casing 153; hence a canister 112 can be made from a material such as a nickel alloy that has a lower electrochemical potential than does a steel casing. But if corrosion of the casing 153 assumes equal importance, as is the case for a 100-year retrievability, then such corrosion currents can be avoided by matching metals.

As another example of reducing or eliminating such corrosion currents, electrical insulation 155 can be positioned between the casing 153 and the canister(s) 112. Possible materials for the insulation 155 include plastics, Teflon, glass, and quartz. If electrons have no good conduction path between the casing 153 and the canister 112, then corrosion currents are reduced or cannot flow. The insulation 155 can be in many forms, including simple spacers, runners, tracks, and rollers (mounted to the canister or otherwise).

As another example of reducing or eliminating such corrosion currents, a sacrificial anode 157 can be used. For example, a sacrificial anode is a metal member with a relatively high electrochemical potential that is placed in the electrolyte and also in electric contact with the casing 153 (not shown in wellbore 104 but can be included) and canister 112. Because of its high electrochemical potential, the corrosion takes place on the surface of the anode 157 rather than on the surfaces of the canister 112 or casing 153. Sacrificial anodes can be used to protect the outside of pipes in oil and gas lines, and on the hulls of sea-going vessels, but they are not currently used inside a directional drillhole that forms a hazardous waste repository to prevent corrosion. Typical metals used for sacrificial anodes are zinc, magnesium, and aluminum. The sacrificial anode 157 can be removed and replaced on a regular schedule, such as once per year (or otherwise), to make sure that corrosion does not accumulate in the casing 153. A sacrificial anode 157 can be placed between canisters 112 (but may not be able to be removed easily), and it can have a corrosion catcher place beneath it (made of a non-corrosive material such as quartz, Teflon, stainless steel, or chrome-plated metal) to prevent any corrosion that sloughs off the sacrificial anode 157 from accumulating on an inner surface of the casing.

In other example implementations according to the present disclosure, 100-year retrievability can also include systems and methods for chemical control of a fluid that fills the hazardous waste repository, such as brine, drilling mud, or other liquid commonly used in the drilling industry. In some aspects, to control or help control corrosion in the drillhole, one or more fluids or fluid additives can be used instead to inhibit corrosion. For example, a corrosion inhibitor fluid 161 can be used to fill a non-canister volume in the drillhole 104 (shown herein the drillhole 124 but applicable to any drillhole). A corrosion inhibitor fluid 161 can also be used to be a driving fluid that pushes cement between the casing 153 and the subterranean formation 110; if used in this manner, the fluid 161 can fill cracks and crevices and other open spaces in the cement 151 and thereby suppress corrosion on the exterior of the casing 153. If a liner is used within the casing 153, then the corrosion inhibitor fluid 161 can be used inside the liner and it can also be used in the space between the liner and the casing 153.

In some aspects, the corrosion inhibitor fluid 161 can be water mixed with corrosion-suppressing chemicals. For example, oxidizing anions such as chromates, nitrites and nitrates that can passivate steel in the absence of oxygen can be a corrosion inhibitor fluid. Non-oxidizing ions such as phosphates, tungstates and molybdates that require the presence of oxygen to passivate can be a corrosion inhibitor fluid. The corrosion inhibitor fluid 161 can contain oxygen scavengers such as sodium sulfite and hydrazine, which react with the oxygen and remove it from the solution. In some aspects, the corrosion inhibitor fluid 161 can include a chemical that would otherwise be prohibitively expensive to use in traditional oil and gas operations but of value in the hazardous waste repository 100 with a 100-year retrievability.

In some aspects, the non-canister volume of the drillhole 124 (or 113 or 104) can be filled with the corrosion inhibitor fluid 161 that is inert, non-conductive, has a strong corrosion suppressant, and also dense enough to provide a counter-pressure to external brines in the host formation. One such fluid is cesium formate (HCOO—Cs+), a dense fluid that is benign environmentally and to human health and is chemically stable to 190° C. (above the expected temperatures in the repository). This fluid, in some aspects, can be mixed with other liquids, such as potassium formate, and still have sufficient density to balance ambient rock brine. Other fluids with these properties (dense, safe for the environment, thermally stable) can also be used. At the end of the 100-year retrieval period this fluid can be recovered and replace with brine.

As noted, the casing 153 can be installed with a layer of cement 151 circulated between it and the subterranean formation 110. In some aspects, the cement 151 can be chosen to be strongly corrosion resistant and to isolate the casing 153 from rock brine. The liquid that pushes the cement 151 into the gap between the casing 153 and the subterranean formation 110 can contain corrosion-inhibitors to reduce corrosion in cracks and crevices in the cement 151.

Other chemical methods can be applied to the fill liquid to inhibit corrosion. The pH of the liquid can be controlled to minimize corrosion. For example, an optimum value of the fluid can be pH=7, but depending on the chemistry, it can be different. During the first hundred years, for nuclear waste as the hazardous waste 115, heat generated by cesium-137 and strontium90 is sufficient to generate substantial convection in the disposal region as well as in the access holes (if they are not plugged) and that will keep the liquid well mixed.

In some aspects, corrosion control can include removal of oxygen from the drillhole, since oxygen is necessary for much corrosion. For example, oxygen can be removed from any liquid (such as the corrosion inhibitor fluid 161) before the liquid is put into the drillhole. One method for doing this is subjecting it to vacuum pumping. Another method is to use oxygen scavengers. Carbon dioxide can also be removed from the fluid 161 (or other fluid such as drilling fluid).

In other example implementations according to the present disclosure, 100-year retrievability can also include systems and methods in which the casing 153 installed in the drillhole 104 includes welded joints. For example, while casing joints are commonly threaded together to form the casing, such joints offer a potential weakness for crevice corrosion. Such corrosion can be significantly reduced by welding the casing joint ends together at the surface 102, rather than threading them together. This process can be cost effective if it adds to the assurance that the casing 153 will not corrode in 100 years.

In example implementations, retrievability of the hazardous waste 15 can be enhanced by emplacing it within a hazardous waste canister designed for a 100-year retrieval. In some aspects, such a canister can include a corrosion-robust latching mechanism to attach to a downhole conveyance (e.g., tubular workstring, coiled tubing, wireline, or otherwise). Often, a conventional latching mechanism for connecting a conveyance to an object in a wellbore uses a screw (or threaded) connection. Such connections have proven quite robust to retrieve downhole objects that have been within a wellbore for short periods, such as years or decades. However, these threaded connections are typically millimeter (mm) in scale Such structures (e.g., the threads) can clog when corrosion is on the same scale. To avoid problems when mm-scale corrosion takes place, the latching mechanism can include one or more components that will still operate robustly even if such mm-scale corrosion occurs on their surfaces.

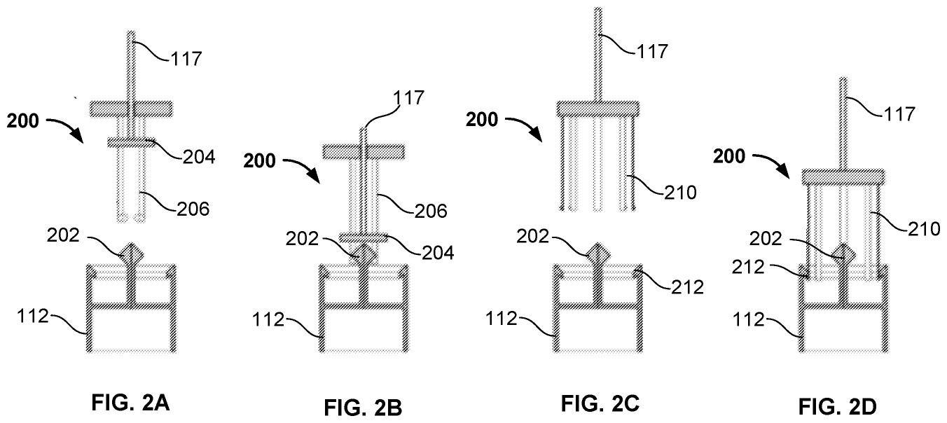

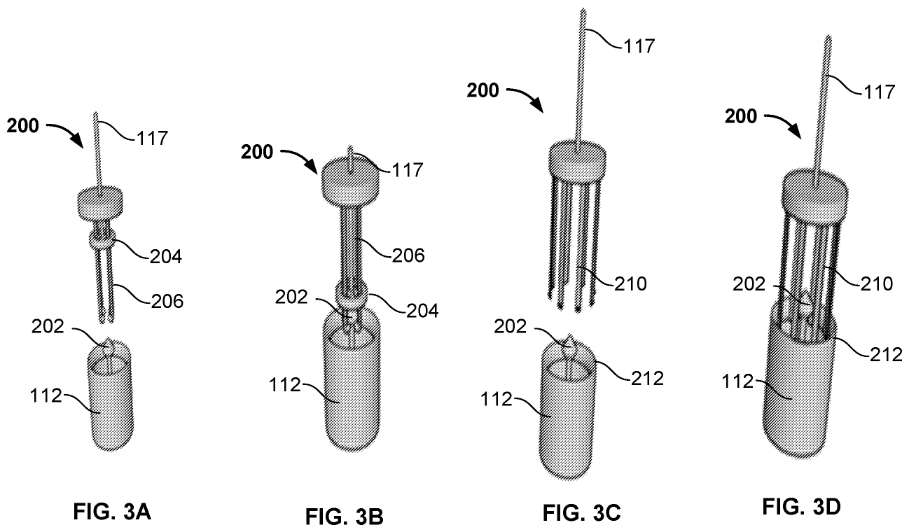

For example, FIGS. 2A-2D are schematic illustrations of an example implementation of a latching mechanism that can be used with a downhole conveyance to retrieve a hazardous waste canister from emplacement within a hazardous waste repository formed in a drillhole. FIGS. 3A-3D are isometric schematic illustrations of the example implementation of the latching mechanism of FIGS. 2A-2D.

FIGS. 2A-2D show an example implementation of a latching assembly 200 (e.g., a downhole wellbore tool) that can be used with a downhole conveyance 117 (e.g., a wireline or other conveyance) to retrieve a hazardous waste canister 112 years from emplacement. FIGS. 3A-3D show isometric views of the example implementation of the latching mechanism shown in corresponding FIGS. 2A-2D.

As shown in FIGS. 2A and 3A, the latching assembly 200 is coupled (e.g., at a top sub-assembly) to the conveyance 117 and includes a locking ring 204 and a latching caliper 206 that can be moved toward the canister 112 within a drillhole. As further shown, the hazardous waste canister 112 can include a knob 202 (or other sufficiently large protrusion) that extends from an end of the canister 112. In FIGS. 2A and 3A, the latching assembly 200 is unattached to the canister 112. In some aspects, the latching calipers 206 can be flexible, and when lowered over the knob 202 of the canister 112, they expand and collapse over it, as shown in FIGS. 2B and 3B. In some aspects, the latching assembly 200 is used only during retrieval; it spends only a very short period of time in the drillhole (hours, not years) and so it will not be subject to significant corrosion. In FIGS. 2B and 3B, the locking ring 204 has been lowered to prevent the calipers 206 from opening. The locking ring 204 is one example component that can assure continued attachment between the conveyance 117 and the canister 112; other components can use non-flexible calipers that can be moved apart mechanically, hydraulically, or electrically, and then closed around the knob 202. In addition, the knob 202 can have a lower surface that locks in the bottom of the calipers 206.

FIGS. 2C and 3C show another form of latching calipers 210 that inserts into an end of the canister 112 and then locks on an inner edge 212 of the canister 112 as shown in FIGS. 2D and 3D. FIGS. 2C and 2D (and FIGS. 3C and 3D) assume no locking ring although a locking ring can also be used in this example. In some aspects, inner latching calipers 206 (shown in FIGS. 2A and 3A and FIGS. 2B and 3B) and outer latching calipers 210 (shown in FIGS. 2C and 3C and FIGS. 2D and 3D) can be combined for redundancy in being able to latch onto the knob 202 and canister edge 212, respectively, to ensure retrieval of the canister 112 to a surface.

In other example implementations according to the present disclosure, 100-year retrievability can also include systems and methods for facilitating movement of an emplaced canister out of a drillhole that includes corrosion. For example, one or more runners (e.g., sled-type runners) can be installed on an exterior surface of a canister, thereby allowing sliding movement of the canister over an uneven surface of a corroded casing or liner.

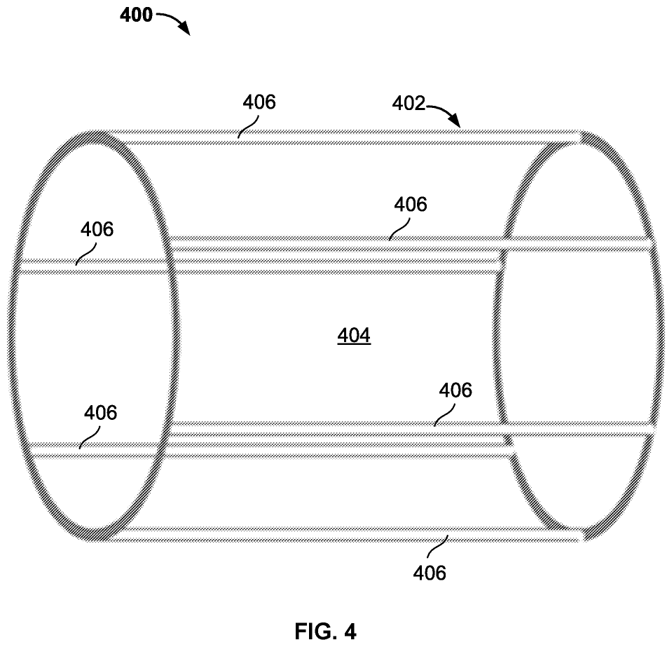

FIG. 4 shows an example implementation of a hazardous waste canister 400 that includes a housing 402 that defines an inner volume 404 sized to enclose hazardous waste (such as hazardous waste 15), and multiple runners 406 installed on the housing 402. In some aspects, the runners 406 can members coupled to or integrated with the housing 402 and be made of an insulting material to provide an electric separation between the canister and casing to inhibit the flow of corrosion currents (as described herein).

Alternatively or additionally to the runners 406, tracks 163 (a short portion of which are shown in FIG. 1) can be installed (at the terranean surface or otherwise) on an interior surface of the casing 153. Tracks 163, like the runners 406, can provide clearance between the canister 112 and any corrosion-produced protrusions on the interior surface of the casing 153. The tracks 163 can be put in place prior to the placement of the canisters 112. In some aspects, tracks 163 can be an integral part of the casing 153 that is installed before the casing 153 is installed into the drillhole 104 (or 124 or 113). In some aspects, tracks 163 can be made from the same material as the casing 153. Alternatively, the tracks 163 can be made of a corrosion-resistant material (e.g., a non-metallic or soft material such as Teflon). In some aspects, the tracks 163 need not be made of a material that has a lifetime much greater than 100 years to still achieve 100-year retrievability.

In other example implementations according to the present disclosure, 100-year retrievability can also include systems and methods for forming a hazardous waste repository and includes multiple access drillhole portions, each with an independent access opening at the terranean surface. For example, when a directional well is drilled, nuclear waste can be disposed within the repository of the drillhole to an end of the horizontal portion (opposite the access drillhole portion). In some aspects, however, a disposal region of the repository can be coupled to two access drillhole portions.

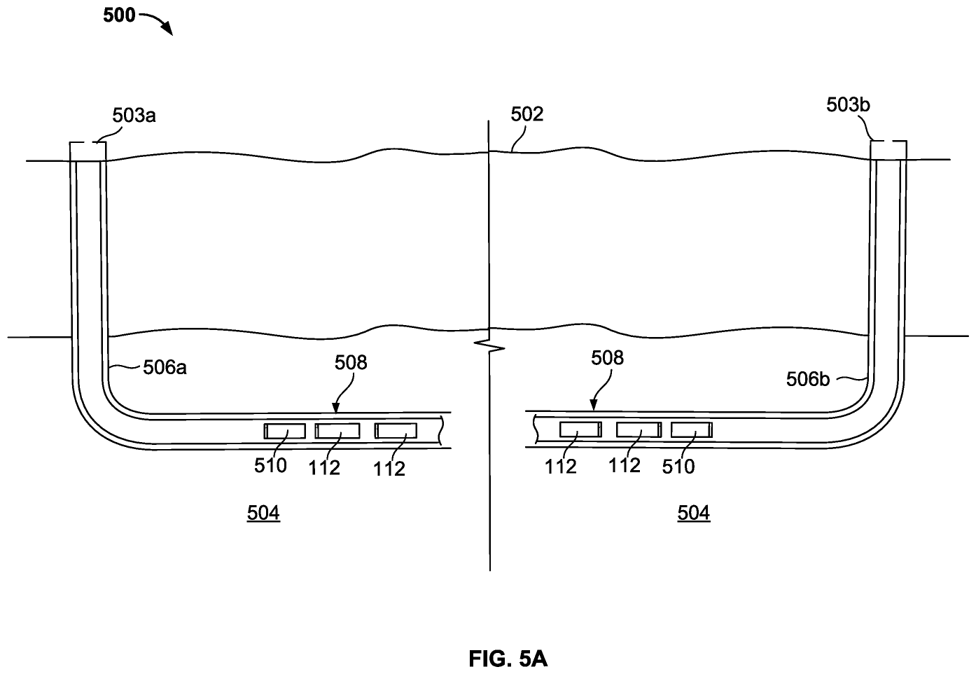

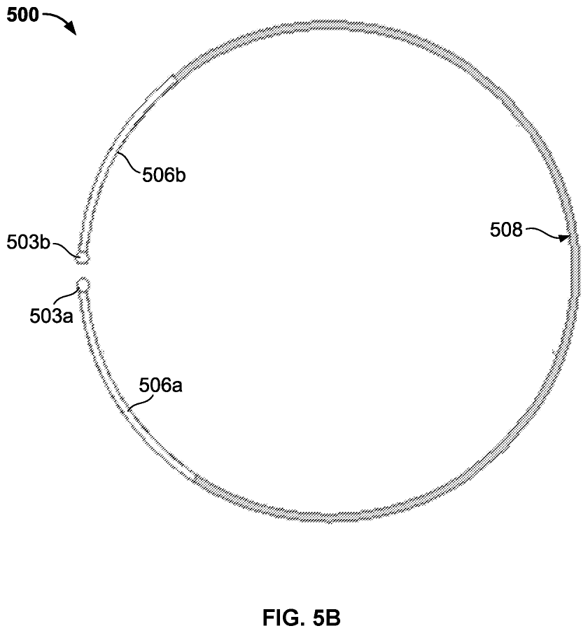

For example, FIG. 5A shows a side view and FIG. 5B shows a plan view of an example hazardous waste repository 500 with two access drillhole portions 506a and 506b, each with a surface opening 503a and 503b (which can be formed from a single well pad) at a terranean surface 502. The access drillhole portions 506a and 506b are each coupled to a storage/disposal region 508 in which hazardous waste canisters 112 can be emplaced. In this example, the repository includes a substantially level (e.g., formed within a subterranean formation 504) but circular storage/disposal region 508.

In this example circular layout, the access portions 506a and 506b can bend not only in a vertical direction (e.g., to create a curve or radius from vertical to horizontal) but also in a horizontal direction, making it level (but circular) when access portions 506a and 506b land in the appropriate subterranean formation 504 (and depth). Thus, in this example, two access drillhole portions 506a and 506b are formed and used to form the disposal region 508. In some aspects, casing can be lowered in one of the access drillhole portions and enter the other access drillhole portion and be pushed or pulled to the surface. In this manner, casing sections need not be connected at depth. Cementing would be done by pumping cement down from the surface.

In some aspects, the example implementation of FIG. 5 can be used to detect corrosion by monitoring a liquid in the storage/disposal region 508 from one or both of the access drillhole portions 506a and 506b. In some aspects, it may not be necessary to pump water though the length of the repository in order to monitor the water at depth. For nuclear waste, there can be significant heat generated by the radioactive decay of Cs-137 and Sr-90 during the monitoring period of 100 years, and this heat can drive convection in both the storage region 508 of the repository 500 and in the vertical portions of the access drillholes 506a and 506b (e.g., as the access drillhole portions can be comprised of both vertical and curved drillhole portions). Thus, the fluid can be well mixed, and additional pumping to sample the liquid may not be necessary.

In some aspects, monitoring of the repository 500 for a possible need of retrieval of one or more canister 112 can include emplacing a full-size and full-weight “dummy” canister 510 (e.g., enclosing no radioactive or other hazardous material) at each end of the storage region 508 adjacent the access drillhole portions 506a and 506b. A program can be instituted of periodic retrieval and then replacement of these end canisters. If one of the access drillhole portions 506a or 506b fails to be capable of delivering the dummy canister 510 to the surface 502, then the other access drillhole portion 506a or 506b can be used immediately to retrieve all the remaining canisters 112 (e.g., canisters 112 that do enclose hazardous waste). The operational principle is that it is not likely that both sides would fail simultaneously. Thus, with this redundancy, there is less need to be certain that corrosion will be negligible for 100 years (or more). If corrosion unexpectedly takes place, it can be detected by the failure to extract one of the dummy canisters 510, and immediate action can be taken to recover canisters 112 that enclose hazardous waste using the other access drillhole portion. This method of monitoring provides evidence that the access drillhole hole corrosion is adequate (or not) for recovery. In some aspects, to facilitate such recovery, the front ends of the canisters should also contain redundant latching knobs (as described in above).

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

What is claimed is:

1. A hazardous waste canister, comprising:
a housing that defines an interior volume configured to store nuclear waste, the housing configured to enclose the nuclear waste in a human-unoccupiable drillhole formed from a terranean surface into a subterranean formation; and
a knob coupled to the housing at an end of the canister, the knob configured to attach to a set of latching calipers of a latching assembly coupled to a downhole conveyance for moving the canister from the human-unoccupiable drillhole to the terranean surface.

2. The hazardous waste canister of claim 1, wherein the knob is coupled or attached to an end of the housing.

3. The hazardous waste canister of claim 2, wherein the set of latching calipers comprises a first set of latching calipers, and the canister comprises a lip configured to couple to a second set of latching calipers of the latching assembly.

4. The hazardous waste canister of claim 3, wherein the lip is at the end of the canister.

5. The hazardous waste canister of claim 1, wherein the housing comprises a corrosion resistant material.

6. The hazardous waste canister of claim 5, wherein the corrosion resistant material is identical to a material of a casing installed in the drillhole.

7. The hazardous waste canister of claim 1, wherein the downhole conveyance comprises a wireline.

8. The hazardous waste canister of claim 1, wherein the nuclear waste comprises spent nuclear fuel.

9. The hazardous waste canister of claim 1, further comprising a plurality of runners installed on the housing.

10. The hazardous waste canister of claim 9, wherein the plurality of runners comprises an electrically insulating material.

11. A downhole tool, comprising:
a top sub-assembly configured to couple to a downhole conveyance; and
a latching assembly, comprising:
at least one set of latching calipers configured to couple to a knob attached to a housing at an end of a hazardous waste canister, the housing defining an interior volume configured to store nuclear waste in a human-unoccupiable drillhole formed from a terranean surface into a subterranean formation; and
a locking ring configured to secure the at least one set of latching calipers coupled to the knob.

12. The downhole tool of claim 11, wherein the downhole conveyance comprises a wireline.

13. The downhole tool of claim 11, wherein the at least one set of latching calipers comprises a first set of latching calipers and a second set of latching calipers.

14. The downhole tool of claim 13, wherein the first set of latching calipers is configured to couple to the knob attached to the housing at an end of the hazardous waste canister.

15. The downhole tool of claim 14, wherein the second set of latching calipers is configured to couple to an outer lip of the housing.

16. A hazardous waste repository, comprising:
a human-unoccupiable drillhole formed from a terranean surface into a subterranean formation, the drillhole comprising a disposal region configured to emplace at least one hazardous waste canister that enclose hazardous waste; and
a casing installed in at least a portion of the drillhole, the casing comprising stainless steel, Teflon, or plastic.

17. The hazardous waste repository of claim 16, wherein the casing and the canister are made from the same material.

18. The hazardous waste repository of claim 16, further comprising electrical insulation positioned between a portion of the casing and the canister.

19. The hazardous waste repository of claim 16, further comprising a sacrificial anode positioned in the drillhole adjacent the canister.

20. The hazardous waste repository of claim 16, wherein the casing comprises a plurality of casing joints welded together.

21. The hazardous waste repository of claim 16, further comprising cement installed between the casing and the subterranean formation.

22. The hazardous waste repository of claim 21, wherein the cement is formed with a corrosion-inhibiting fluid.

23. The hazardous waste repository of claim 16, further comprising a corrosion-inhibiting fluid circulated into the drillhole between the casing and the canister.

24. The hazardous waste repository of claim 16, further comprising one or more tracks installed on an inner surface of the casing to facilitate movement of the canister in the drillhole.

25. The hazardous waste repository of claim 24, wherein the one or more tracks are made of a corrosion-resistant material.

26. A hazardous waste repository, comprising:
a human-unoccupiable drillhole formed from a terranean surface into a subterranean formation, the drillhole comprising:
a first access drillhole portion formed from the terranean surface toward or into the subterranean formation;
a second access drillhole portion formed from the terranean surface toward or into the subterranean formation; and
a disposal drillhole region formed in the subterranean formation and configured to emplace one or more hazardous waste canisters that enclose hazardous waste, wherein the disposal drillhole region is coupled within the subterranean formation to the first and second access drillhole portions.

27. The hazardous waste repository of claim 26, wherein the first and second access drillhole portion displace vertically and laterally from respective first and second entry drillhole portions.

28. The hazardous waste repository of claim 26, wherein the disposal drillhole region is circular in shape.

29. The hazardous waste repository of claim 26, wherein the human-occupiable drillhole comprises a flow path for a fluid to be circulated therethrough.

30. The hazardous waste repository of claim 29, wherein the flow path comprises an inlet at the first access drillhole portion and an outlet at the second drillhole portion.

31. The hazardous waste repository of claim 26, wherein the one or more hazardous waste canisters comprises a plurality of hazardous waste canisters emplaced in the disposal drillhole region, each of the plurality of hazardous waste canisters enclosing hazardous waste.

32. The hazardous waste repository of claim 31, further comprising at least one dummy canister that does not include hazardous waste.

33. The hazardous waste repository of claim 32, wherein the at least one dummy canister comprises a first dummy canister positioned at a first end of the plurality of hazardous waste canisters and a second dummy canister positioned at a second end of the plurality of hazardous waste canisters opposite the first end.
